(19) United States
(12) Patent Application Publication
(10) Pub. No.: US 2023/0399490 A1
(43) Pub. Date: Dec. 14, 2023

(54) POROUS CERAMIC POLYMER COMPOSITES FOR PREVENTING RODENT DAMAGE

(71) Applicant: CORNING RESEARCH & DEVELOPMENT CORPORATION, Corning, NY (US)

(72) Inventors: Monika Backhaus-Ricoult, Bourron (FR); Linda Sue Baker, Addison, NY (US); Edward John Fewkes, Modoc, SC (US); Zachary Andrew Fewkes, Corning, NY (US)

(21) Appl. No.: 18/239,854

(22) Filed: Aug. 30, 2023

Related U.S. Application Data
(63) Continuation of application No. PCT/US22/18631, filed on Mar. 3, 2022.
(60) Provisional application No. 63/157,038, filed on Mar. 5, 2021.

(51) Int. Cl. C08K 3/36; C08K 5/00; C08K 7/26; G02B 6/44

(52) U.S. Cl. CPC C08K 3/36; C08K 5/00; C08K 7/26; G02B 6/443

(57) ABSTRACT

Embodiments of a polymer composition are provided. The polymer composition incudes at least one polymer and an aversive additive dispersed in the at least one polymer. The aversive additive includes a porous inorganic material having pores and an aversive material contained within the pores of the porous inorganic material. In embodiments, the polymer composition may be incorporated as jacketing into an optical fiber cable. Also disclosed is a method including the step of infusing an aversive material into a porous inorganic material to form an aversive additive. The porous inorganic material includes particles having an average porosity of from 25% to 75% and a median diameter of 100 μm or less.

### CROSS-REFERENCE TO RELATED APPLICATION

This application is a continuation of International Application No. PCT/US2022/018631 filed Mar. 3, 2022, which claims the benefit of priority under 35 U.S.C. § 119 of U.S. Provisional Application No. 63/157,038, filed on Mar. 5, 2021, the content of which is relied upon and incorporated herein by reference in its entirety.

### BACKGROUND

The disclosure relates generally to aversive materials and more particularly to aversive additives for cable jackets. Cables, such as power transmission cables, telephone cables, optical fiber cable, etc., are used to transmit electricity and/or data over distance. In order to do so, the cables have to be strung across land and/or buried in the ground between electricity/data sources and delivery points. Rodents have been known to chew on cables, which damages the cables and which can cause cable failure. Indeed, some estimates attribute approximately 17% of damage to aerial cables to squirrels alone. Other polymer articles are also subject to rodent chewing damage.

### SUMMARY

In one aspect, embodiments of a polymer composition are provided. The polymer composition includes at least one polymer and an aversive additive dispersed in the at least one polymer. The aversive additive includes a porous inorganic material having pores and an aversive material contained within the pores of the porous inorganic material.

In another aspect, embodiments of a method are provided. The method includes the step of infusing an aversive material into a porous inorganic material to form an aversive additive. The porous inorganic material includes particles having an average porosity of from 25% to 75% and a median diameter of 100 μm or less.

In still another aspect, embodiments of an optical fiber cable are provided. The optical fiber cable includes at least one optical fiber and a polymeric jacket that surrounds the at least one optical fiber. The polymeric jacket is made of a polymer matrix and an aversive additive dispersed in the polymer matrix. The aversive additive includes a porous inorganic material having pores and an aversive material contained within the pores of the porous inorganic material.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. In the drawings:

FIG. 1 depicts a flow diagram of a method of preparing and deploying an aversive additive, according to an exemplary embodiment;

FIG. 2 includes SEM images of cordierite particles for carrying an aversive material at various magnifications, according to an exemplary embodiment;

FIG. 3 is an SEM image of halloysite tubes for carrying an aversive material, according to an exemplary embodiment; and

FIG. 4 depicts an optical fiber cable having one or more cable components in which the aversive additive was dispersed, according to an exemplary embodiment.

### DETAILED DESCRIPTION

Referring generally to the figures, various embodiments of an aversive additive for repelling rodents, birds, insects, monkeys, and other animals from structures made from or including polymers are provided. In many outdoor environments, animals tend to chew, gnaw, climb, or otherwise interact with man-made structures, such as electrical or telecommunication cables, which can cause these structures to prematurely fail, degrade, or be rendered unsuitable for their intended purpose. Aversive materials are used to repel animals before the animals have a chance to injure themselves or to cause damage to the structure. However, in certain circumstances, conventional aversive materials tend to bleed from the matrix in which they are deployed, experience environmental degradation, and/or require reapplication. In contrast, the aversive materials according to embodiments of the present disclosure are infused in a porous inorganic material, which allows the aversive additive to be compounded at high temperatures with a polymer, to be highly resistant to environmental degradation, to be dispersed evenly throughout the polymer, and to be released upon interaction with an animal. In an embodiment, the aversive additive is incorporated in a polymer composition used, e.g., as a jacket material in an optical fiber cable. These and other embodiments will be described herein and in relation to the figures. Such exemplary embodiments are provided by way of illustration and not by way of limitation.

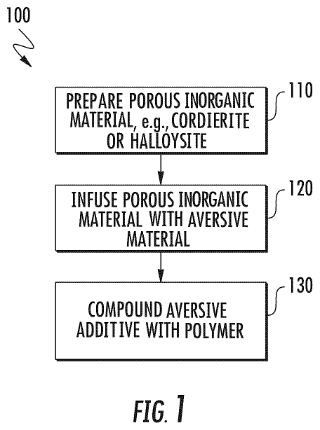

Referring to FIG. 1, a method 100 of preparing and deploying the aversive additive is provided. Generally, the method of preparing the aversive additive involves infusing an aversive material into a porous inorganic material. In embodiments, the porous inorganic material is a ceramic material, in particular a clay. In embodiments, the porous inorganic material includes one or more of cordierite, halloysite, aluminum-titanate composites, magnesium silicate composites, eucryptite, and other silicates, oxides, or hydroxides. In general, the porous inorganic material is provided in the form of micro- or nano-beads, micro- or nano-tubes, and/or powders.

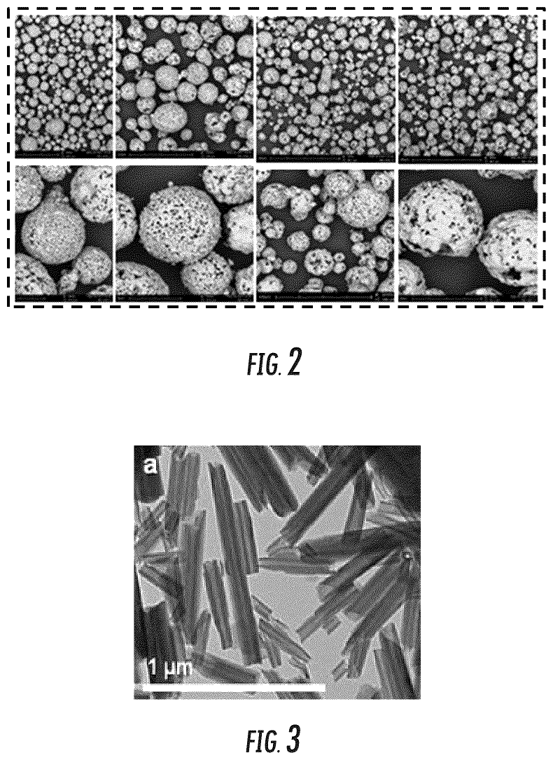

In an embodiment, the porous inorganic material includes cordierite. FIG. 2 depicts SEM images of porous cordierite beads that can be infused with an aversive material. In embodiments, the cordierite beads have a median diameter of from 12 μm to 100 μm. While as depicted in FIG. 2 the cordierite beads have a generally spherical shape, “diameter” as used herein is not meant to imply that the particles are perfectly spherical or has a perfectly circular cross section. Instead, “diameter” as used herein refers to the maximum cross-sectional dimension of a particle, such as the cordierite beads. In further embodiments, the cordierite beads have a median diameter of from 10 μm to 80 μm, in particular from 20 μm to 70 μm, and most particular from 30 μm to 60 μm. Further, in embodiments, the cordierite beads include pores having median pore sizes of from 0.5 μm to 2 μm, in particular from 0.6 μm to 1.8 μm. The “pore size” refers to the pore channel bottle neck diameter as measured by mercury intrusion porosimetry. Further, in embodiments, the cordierite beads have a porosity of from 25% to 75%, in particular from 25% to 60%, and more particularly from 28% to 55%.

In embodiments, the cordierite beads are formed from a slurry of cordierite-forming inorganic precursors and water mixed with organic binders and dispersants. In an embodiment, the slurry is spraydried in a spraydryer (e.g., using any medium scale spraydryer known in the art). Many different inorganic combinations can be used to create cordierite beads. In general, the cordierite beads are formed from slurries containing a combination of two or more of talc, alumina, silica, clays (e.g., kaolin), spinel, MgO, Mg(OH)₂, MgCO₃, and Al(OH)₃, among other precursors containing Al, Mg, or Si. The components of the slurry are selected so that, after calcining, the composition is close to that of cordierite (e.g., Mg₂Al₄Si₅O₁₈). Table 1 provides two examples of slurries used to form cordierite beads.

TABLE 1
Composition of Cordierite Slurries

| Cordierite 1 | Amount (g) | Cordierite 2 | Amount (g) |
|---|---|---|---|
| Clay | 72.67 | Alumina | 74.55 |
| Mg(OH)₂ | 18.04 | Montana Talc | 40.20 |
| Silica | 9.29 | Hydrated Alumina | 18.42 |
| | | Silica Soot | 14.25 |
| | | Hydrous Kaolin | 11.58 |
| | | Sodium Stearate | 1.00 |
| Total Inorganics: | 100.00 | Total Inorganics: | 100.00 |
| Water | 105 mL | Water | 87 mL |

The clay in Cordierite 1 was kaolin clay (available from BASF SE, Ludwigshafen, Germany). The Mg(OH)₂ was MAGSHIELD® (available from Martin Marietta Magnesia Specialties, LLC, Raleigh, NC). The silica was IMSIL® A-8 (available from Covia, Independence, OH). The alumina in Cordierite 2 was A 152 SG (available from Almantis, Inc., Leetsdale, PA).

As can be seen from Table 1, the slurry of Cordierite 1 includes 100.00 grams of inorganics mixed with 105 mL of water, and the slurry of Cordierite 2 includes 100.00 grams of inorganics mixed with 87 mL. Both slurries were further mixed with 2 g of styrene acrylic polymer binder (available from DuPont de Nemours, Inc., Wilmington, DE) and 0.2 g ammonium salt of acrylic polymer as dispersant.

In embodiments, the aqueous slurries are spraydried using an atomizer nozzle or a two-fluid nozzle. Various operating parameters can be manipulated to produce a targeted bead size, such as slurry solid loading, atomizer rotation rate, pressure, and operating temperature, among others. In embodiments, the spraydried particles are calcined in alumina trays in a box furnace or in alumina tubing in static or continuous rotary calciners. The heating rate during calcining ranged from 50° C./h to 300° C./h. As shown in Table 2, the calcining top temperatures were from 1100° C. to 1410° C. with hold times of two hours to eight hours. Calcining was conducted in air or under air flow to burn off the organic binder and dispersant. The calcined powders were cooled to room temperature at a rate of 30° C./h to 200° C./h.

TABLE 2
Porosity Data for some of the Porous Cordierite Beads

| | | d10 | d50 | d90 | Porosity | Pore size |
|---|---|---|---|---|---|---|
| Composition | Firing Cycle | (μm) | (μm) | (μm) | (%) | (μm) |
| Cordierite 1 | 1150° C./4 h | 28.19 | 53.31 | 85.52 | 49.81 | 0.6 |
| Cordierite 1 | 1250° C./4 h | 28.25 | 52.68 | 84.31 | 45.45 | 1.08 |
| Cordierite 1 | 1350° C./6 h | 30.6 | 58.71 | 98.31 | 27.79 | 4.4 |
| Cordierite 2 | 1150° C./4 h | 29.05 | 45.3 | 68.08 | 54.41 | 0.6 |
| Cordierite 2 | 1250° C./4 h | 32.71 | 46.1 | 67.21 | 51.8 | 1.02 |
| Cordierite 2 | 1350° C./6 h | 26.38 | 38.15 | 57.09 | 37.61 | 1.83 |

The resulting powders were composed of individual, generally spherical particles. Firing was conducted in a fashion that prevented agglomeration. The resulting powders were sieved through 140 or 270 mesh screens to eliminate occasional larger particles. The resulting particle size distribution is described in Table 2 based on the percentage of particles that were below a certain size. Thus, “d10” as used in Table 2 indicates that 10% of particles had a diameter below the value listed in the d10 column. Similarly, “d50” indicates that 50% of particles had a diameter below the value listed in the d50 column, and “d90” indicates that 90% of particles had a diameter below the value listed in the d90 column. The value d50 is also referred to as the median diameter of the beads.

The porosity in the bead was determined by mercury intrusion porosimetry (MIP) and visualized by scanning electron microscopy (SEM) on powders and polished cross sections. FIG. 2 depicts SEM images of the porous cordierite beads obtained from the above-described process.

In another embodiment, the porous inorganic material includes halloysite, which, as shown in FIG. 3, has the shape of nano-sized tubes. In particular embodiments, the halloysite tubes have a length of 0.2 μm to 1.5 μm. Further, in embodiments, the halloysite tubes have an inner diameter, defining a lumen, of 10 nm to 30 nm. The outer and inner surfaces of the halloysite tubes are oppositely charged at neutral pH as a result of a silica rich exterior and an alumina rich interior. The size and tube diameter of the halloysite can vary based on the source and based on whether the halloysite tubes have been treated with acid, which can increase the tube diameter.

After the preparing the porous inorganic material in the first step 110, the porous inorganic material is infused with an aversive material in a second step 120. As used herein, an aversive material is one that will repel an animal in the particular environment in which the aversive material is used. Generally, the aversive material will trigger a flavor, olfactory, or tactile response in the animal, repelling the animal from, e.g., chewing, pecking, or climbing on the structure containing the aversive material. In embodiments, the aversive material is an organic material. Examples of suitable organic aversive materials include cinnamaldehyde, wintergreen oil, capsaicin, peppermint oil, bergamot oil, geranium oil, predator urine, eucalyptus, bitterants, pinene, lemon citrus oil, cedarwood oil, garlic oil, and any other organic aversive materials known in the art to produce an aversive reaction to an animal or animals in any or all environments. In other embodiments, the aversive material is an inorganic material. Examples of inorganic aversive materials include fine fibers or fibrils that can tickle or create a burning sensation when particles of the porous inorganic material are bitten. In embodiments, the porous inorganic material is infused with a precursor liquid (e.g., LUDOX® colloidal silica, available from W. R. Grace and Company, Columbia, MD), and then, in a low temperature drying growth process, fibrils (e.g., silica or carbon fibrils) are grown on the particles of the porous inorganic material. In embodiments, the fibrils may have a length, e.g., 1 μm or greater, 10 μm or greater, or 25 μm or greater, and a diameter of 1 μm or less.

In an embodiment, a solution of the aversive material and a solvent is prepared. In embodiments, the solution may contain 10:90 to 50:50 ratio of solvent to aversive material. In embodiments, the solvent is used to lower the viscosity of the aversive material so that the solution containing the aversive material can infuse into the pores of the porous inorganic material. A variety of solvents may be used to form the aversive solution so long as the aversive material is soluble in the solvent. Thereafter, in embodiments, the porous inorganic material is infused with the aversive solution. In embodiments, the ratio of porous inorganic material to aversive solution is from 1:2 to 1:20. In embodiments, the mixture of porous inorganic material and aversive solution is sonicated and placed under vacuum (e.g., 10 inHg to 29.5 inHg) to assist infusion. The mixture may remain under vacuum for a time of 20 minutes to 120 minutes, and the vacuum is slowly released to atmospheric pressure over a time period of, e.g., 30 minutes to 4 hours.

In an experimental embodiment, samples of cordierite and halloysite were infused with a 50:50 ethanol:cinnamaldehyde solution at 1 part porous inorganic material to 10 parts aversive solution. The samples were sonicated in the solution and placed in a vacuum desiccator for a time period of over 20 minutes. Vacuum was pulled at 24 inHg. The vacuum was released slowly over 30 minutes to allow infusion of the aversive solution into the pores of the porous inorganic material. The samples were then centrifuged, the solution was decanted, and the material was rinsed and centrifuged with ethanol, followed by 50:50 ethanol:water, and finally water. The samples were then dried by lyophilization. The process was repeated for infusing the aversive materials of capsaicin and dihydrocapsaicin in the porous inorganic material.

Ultra performance liquid chromatography (using Waters Acquity H-Class UPLC with PDA detector) was used to confirm and quantify cinnamaldehyde in infused porous materials. Over a period of 2 to 4 days, 100 mg to 1 g of material was extracted at 40° C. in ethanol. Maximum concentrations of 225 μg/ml and 1 mg/ml cinnamaldehyde were measured for infused cordierite and halloysite samples, respectively. Concentration of capsaicinoids were up to 30 μg/ml in infused halloysite nanotubes. In embodiments, the concentration of aversive material in the porous inorganic material is from 60 ng/ml to 10 mg/ml.

After infusing the porous inorganic material with aversive material in the second step 120, the aversive additive was then compounded with a polymer in step 130. The aversive additive can be compounded with a variety of suitable polymers, including thermoplastic polymers, thermoset polymers, elastomers, and thermoplastic elastomers. Exemplary polymers include ethylene-vinyl acetate copolymers, ethylene-acrylate copolymers, polyethylene homopolymers (low, medium, and high density), linear low density polyethylene, very low density polyethylene, polypropylene homopolymer, polyolefin elastomer copolymer, polyethylene-polypropylene copolymer, butene- and octane-branched copolymers, or maleic anhydride-grafted versions of the polymers listed above. In another embodiment, exemplary polymers include halogenated thermoplastics (such as polyvinyl chloride); polyamide 6, 6/6, 11, or 12 resins, thermoplastic polyurethane; or a crosslinked polyethylene. In the experimental embodiment, the aversive additive was compounded with medium density polyethylene (MOPE).

In an embodiment, the aversive additive is mixed with other optional polymer additives prior to or during compounding. Typical polymer additives include pigments, stabilizers, fungicides, and fillers. In embodiments, the aversive additive comprises between 1% and 30% by weight of the polymer composition. In certain embodiments, the aversive additive other polymer additives together comprise from 2% to 50% by weight of the polymer composition.

In the exemplary embodiment, 1.5%-3.5% by weight of the aversive additive was compounded with the MDPE in an 11 mm twin screw extruder (available from Thermo Fisher Scientific Inc., Waltham, MA). The die temperature of the extruder was set to 200° C. The zone temperatures increased from 160° C. to 190° C. Screw speed was set to 150 rpm.

Advantageously, the porous inorganic material protected the aversive material during compounding and extrusion despite exposure to temperatures of greater than 150° C., which might otherwise cause degradation of an unprotected aversive material. In this way, the aversive additive as described herein can be extruded or molded with or otherwise dispersed in a polymer usable in a variety of applications. In some embodiments, the aversive additive described herein is added to a thermoplastic polymer material that is then melted and shaped through extrusion, injection molding, compression molding or any other suitable process to form a polymeric article. In other embodiments, the aversive additive described herein is added to a polymer precursor mixture that is then cured or cross-linked, e.g., via UV, heating, etc., to form a polymeric article.

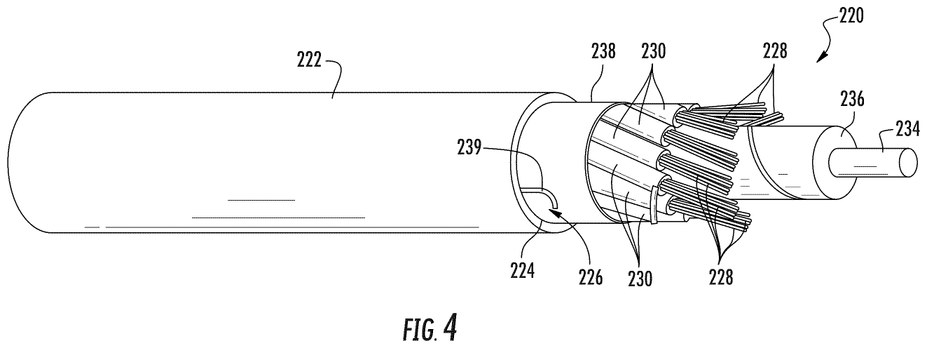

In embodiments, the aversive additive is included in extruded jacketing for cables, such as electrical communication cables, optical communication cables, etc. In a particular embodiment as shown in FIG. 4, the aversive additive is shown as part of an optical fiber cable 220. Cable 220 includes a cable body, shown as polymeric jacket 222, having an inner surface 224 that defines a channel, shown as central bore 226. In embodiments, the polymer jacket 222 is the outermost layer or jacket of the cable 220, making it the first part of the cable 220 exposed to animals. Pluralities of communication elements, shown as optical fibers 228, are located within bore 226. The cable 220 includes a plurality of core elements located within central bore 226. A first type of core element is an optical transmission core element, and these core elements include bundles of optical fibers 228 that are located within tubes, shown as buffer tubes 230. Buffer tubes 230 are arranged around a central support, shown as central strength member 234. Central strength member 234 includes an outer coating layer 236. A barrier material, such as water barrier 238, is located around the stranded buffer tubes 230. An easy-access structure, shown as rip cord 239, may be located inside polymeric jacket 222 to facilitate access to buffer tubes 230.

In one embodiment, the aversive additive is incorporated into the polymeric jacket 222 of fiber optic cable 220. In another embodiment, the aversive additive is incorporated into the buffer tubes 230 surrounding the bundles of optical fibers 228. In a further embodiment, the aversive additive is incorporated into the water barrier 238. In still another embodiment, the aversive additive is incorporated into the outer coating layer 236. By extruding a polymer containing the aversive additive around the cable and cable components, the cable 220 is less susceptible to damage from rodents, birds, insects, monkeys, and other animals, and the aversive additive will remain stable in the cable 220 much longer than conventional aversive additives such that reapplication is not required. Moreover, such cables do not need the extensive metal armors that are frequently required in conventional cables to protect against animal-related damage. Dispensing with these metal armors reduces the weight and expense of the cable.

The embodiments of the aversive additive incorporated into the optical fiber cable 220 are provided for the purposes of illustration only and not by way of limitation. Indeed, the aversive additive can be incorporated in many other objects using a polymer as a coating and/or as a component.

Despite being contained and protected, thermally and mechanically, in the porous inorganic material, the aversive additive as disclosed herein is readily available to dissuade animals from interacting with the polymer composition in which the aversive additive is incorporated. Indeed, the aversive material is released from the porous inorganic material under bite pressure. Further, the porous inorganic material itself can act as an aversive material because the porous inorganic material (e.g., cordierite) may be hard, causing discomfort when bitten. Additionally, the size of the porous inorganic material particles can be manipulated to smaller diameters to enhance this effect. Moreover, the small particles and/or broken inorganic material may cause discomfort and may reside in the animal's mouth for a longer period of time, increasing the aversive effect. Notwithstanding, the toxicity of the aversive additive is low despite its overall designed unpleasantness.

Further still, the incorporation of the aversive material in the porous inorganic material provides processing and deployment advantages. In particular, the aversive material contained in the porous inorganic material in a stable manner such that it is only released under the pressure of biting, clawing, etc. Accordingly, aversive additives containing a variety of different aversive materials can be prepared and mixed during compounding to provide various desired aversive profiles based on the particular animals and/or geographic regions expected to be encountered. Further, the aversive additives can be incorporated into various mediums that can be used to coat cables in the field, e.g., by spraying or brushing. The aversive additive can also easily be extended to other applications, such as tapes, enclosures, and/or other materials encountered in rodent entry pathways to buildings.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein the article “a” is intended include one or more than one component or element, and is not intended to be construed as meaning only one.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A polymer composition, comprising:
at least one polymer; and
an aversive additive dispersed in the at least one polymer, the aversive additive comprising:
a porous inorganic material comprising pores; and
an aversive material contained within the pores of the porous inorganic material.

2. The polymer composition of claim 1, wherein the porous inorganic material comprises at least one of cordierite, halloysite, aluminum-titanate composites, magnesium silicate composites, or eucryptite.

3. The polymer composition of claim 1, wherein the porous inorganic material comprises cordierite beads having a median diameter of from 15 μm to 100 μm.

4. The polymer composition of claim 3, wherein the cordierite beads have an average porosity of from 25% to 75%.

5. The polymer composition of claim 4, wherein the pores of the cordierite beads comprise an average size of from 0.5 μm to 2 μm.

6. The polymer composition of claim 1, wherein the porous inorganic material comprises halloysite tubes having a length of 0.2 μm to 1.5 μm.

7. The polymer composition of claim 6, wherein the halloysite tubes have an average inner diameter of from 10 nm to 30 nm.

8. The polymer composition of claim 1, wherein a concentration of aversive material in the porous inorganic material is from 60 ng/ml to 10 mg/ml as measured by ultra performance liquid chromatography.

9. The polymer composition of claim 1, wherein the aversive material includes at least one of cinnamaldehyde, wintergreen oil, capsaicin, peppermint oil, bergamot oil, geranium oil, predator urine, eucalyptus, bitterants, pinene, lemon citrus oil, cedarwood oil, or garlic oil.

10. The polymer composition of claim 1, wherein the aversive material comprises fibrils of inorganic material grown on the porous inorganic material, the fibrils having a length greater than 1 μm and a diameter of less than 1 μm.

11. The polymer composition of claim 1, comprising from 1% to 30%, by weight, of the aversive additive.

12. A method, comprising:
infusing an aversive material into a porous inorganic material to form an aversive additive, the porous inorganic material comprising particles having an average porosity of from 25% to 75% and a median diameter of 100 μm or less.

13. The method of claim 12, wherein the step of infusing comprises subjecting a mixture of the porous inorganic material and a solution containing the aversive material to a vacuum pressure in the range of 10 inHg to 29.5 inHg and releasing the vacuum pressure to atmospheric pressure over a time period of at least 30 minutes so as to allow the solution containing the aversive material to infuse into pores of the particles of the porous inorganic material.

14. The method of claim 12, wherein the aversive material is colloidal silica and wherein the method further comprises growing silica fibrils on the particles of the porous inorganic material, the fibrils having a length of at least 1 μm and a diameter of 1 μm or less.

15. The method of claim 12, wherein the porous inorganic material comprises cordierite and the method further comprises:
preparing a slurry of inorganic compounds, water, and binders;
spray drying the slurry to form a powder; and
calcining the powder.

16. The method of claim 12, further comprising the step of compounding the aversive additive with a polymer to form a polymer composition, wherein the aversive additive comprises from 1% to 30% by weight of the polymer composition.

17. The method of claim 16, further comprising the step of extruding the polymer composition at a temperature of at least 150° C.

18. The method of claim 12, further comprising the step of selecting the aversive material to be at least one of cinnamaldehyde, wintergreen oil, capsaicin, peppermint oil, bergamot oil, geranium oil, predator urine, eucalyptus, bitterants, pinene, lemon citrus oil, cedarwood oil, or garlic oil.

19. The method of claim 12, further comprising the step of selecting the porous inorganic material to be at least one of cordierite, halloysite. aluminum-titanate composites, magnesium silicate composites, or eucryptite.

20. An optical fiber cable, comprising:
at least one optical fiber; and
a polymeric jacket that surrounds the at least one optical fiber;
wherein the polymeric jacket comprises:
a polymer matrix; and
an aversive additive dispersed in the polymer matrix, the aversive additive comprising:
a porous inorganic material comprising pores; and
an aversive material contained within the pores of the porous inorganic material.

21. The optical fiber cable of claim 20, wherein the porous inorganic material comprises at least one of cordierite, halloysite. aluminum-titanate composites, magnesium silicate composites, or eucryptite.

22. The optical fiber cable of claim 21, wherein the aversive material comprises at least one of cinnamaldehyde, wintergreen oil, capsaicin, peppermint oil, bergamot oil, geranium oil, predator urine, eucalyptus, bitterants, pinene, lemon citrus oil, cedarwood oil, or garlic oil.

23. The optical fiber cable of claim 20, wherein the porous inorganic material comprises cordierite having an average diameter of from 15 μm to 100 μm, an average pore size of from 0.5 μm to 2 μm, and an average porosity of from 25% to 75%.

24. The optical fiber cable of claim 20, wherein the porous inorganic material comprises halloysite tubes having a length of 0.2 μm to 1.5 μm and an average inner diameter of from 10 nm to 30 nm.

25. The optical fiber cable of claim 20, wherein the polymeric jacket is an outermost jacket of the optical fiber cable.
